(19) United States
(12) Patent Application Publication
(10) Pub. No.: US 2009/0147104 A1
(43) Pub. Date: Jun. 11, 2009

(54) Camera device having an odor recording function and a method thereof

(76) Inventor: Feng-Hsing Wang, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,025

(22) Filed: Mar. 13, 2008

(30) Foreign Application Priority Data
Dec. 7, 2007 (TW) 96146719

(51) Int. Cl. H04N 5/76

(52) U.S. Cl. 348/231.99

(57) ABSTRACT

A camera device having an odor recording function and a method thereof is disclosed to overcome the shortage of the prior art that digital cameras cannot record odor or smell while taking pictures. The present invention adds an odor detection unit to detect the environmental odor and converts the odor into digital form. The firmware of the digital camera saves the image data as an image file and embeds the odor data in the specific area of the digital image file. The present invention can cooperate with the printer possessing the odor printing function to print the digital image file with the designated odor.

### BACKGROUND OF THE INVENTION

1. Field of the Invention

The present invention relates to a camera device having an odor recording function and a method thereof. In particular, this invention relates to a camera device having an odor recording function and a method thereof that can record the environmental odor while a picture is taken.

2. Description of the Related Art

In early days, people usually used an analog still camera and a film to take pictures and sent the film to the photo studio for developing the pictures taken. As the digital camera invented, the way for taking pictures changed. The consumer can use a digital camera to capture scenery and store the captured data in a recordable medium, such as a memory card, in digital form.

With the development of technology, in addition to the basic function of taking pictures, a digital camera can also provide many extra functions like recording sounds, audio, and even moving videos. The user can use a digital camera to capture still or moving images and to record audio or sounds easily.

Reference is made to FIG. 1, which shows the flow chart of a digital camera performing a picture-taking and picture-storing operation. To take a picture using a digital camera, the user firstly turns on the digital camera and selects the scene which will be taken (S100). Next, the user adjusts the lens and the focal length of the digital camera (S102), and takes a picture of the scene (S104). The captured image is stored in the recordable medium in digital form (S106). Finally, the user navigates the pictures on the display screen of the digital camera or prints the digital images stored in the recordable medium at a photo studio.

However, although nowadays the digital camera has provided a lot of functions as mentioned previously, it still cannot allow the user to record the environmental odor or smell of a spot while taking a picture of that spot. This therefore limits the joys of navigating the pictures taken afterwards.

### SUMMARY OF THE INVENTION

To overcome the shortage that a digital camera cannot provide the function of odor recording, the present invention suggests a method and a device thereof. The objective of the invention is to add the odor recording ability for hand-held camera devices, such as digital cameras, PDAs, or video cameras, to enhance the user experience and the value of hand-held camera devices.

To achieve the objective mentioned above, in the present invention the camera device having an odor recording function should comprise the following units: A photographing unit, an odor detection unit, a quantization unit, a combination unit, and a storage unit. The photographing unit is used for converting the natural scenery into at least one digital image. The odor detection unit detects at least one odor of the photographing spot and converts the odors detected into at least one odor in digital form. The quantization unit quantizes the digital odor data to reduce the data size of the odor. The combination unit combines the odor data with the digital image data to form at least one image file. The storage unit stores the generated image file with the odor data in the recordable medium.

To achieve the, objective mentioned above, the present invention presents a photographing method for recording odor. Firstly, the photographing unit captures a scene and converts the captured image into digital form. During taking the picture, the odor detection unit detects at least one odor of the photographing spot and converts the odors detected into digital form. Then, in the quantization unit, the odors detected are sorted according to their concentration. Then, according to whether a quantization option is picked or not, a quantization step will be performed or ignored. If the quantization step is performed, each of the detected odors will be quantized as a single-value index. Finally, the combination unit stores the digital image data as a file and puts the original digital odor data or the quantized odor indices with the information of whether a quantization operation is performed in a specific area of this digital image file.

A hand-held camera device (such as a digital camera, a PDA, or a video camera), which wants to apply the present invention for having the odor recording function, only needs to install an odor detection unit. Then, the user can record odor while taking pictures. When viewing the pictures taken on the computer, if the user has installed an odor distributing device and a photo browser which is capable of identifying the odor information stored in the pictures, the photo browser will send the odor information to the odor distributing device so that the odor distributing device can distribute the corresponding odor. The user can view the picture and smell the odor at the same time. Also, if a printer which provides the odor printing ability is connected, the user can have a printed copy of the picture which disperses the corresponding smell.

For further understanding of the invention, reference is made to the following detailed description illustrating the embodiments and examples of the invention. The description is only for illustrating the invention and is not intended to limit the scope of the claim.

### BRIEF DESCRIPTION OF THE DRAWINGS

The drawings included herein provide a further understanding of the invention.

A brief introduction of the drawings is as follows:

FIG. 1 is a flow chart showing how a general digital camera performs a picture-taking process and a picture-storing operation in the prior art;

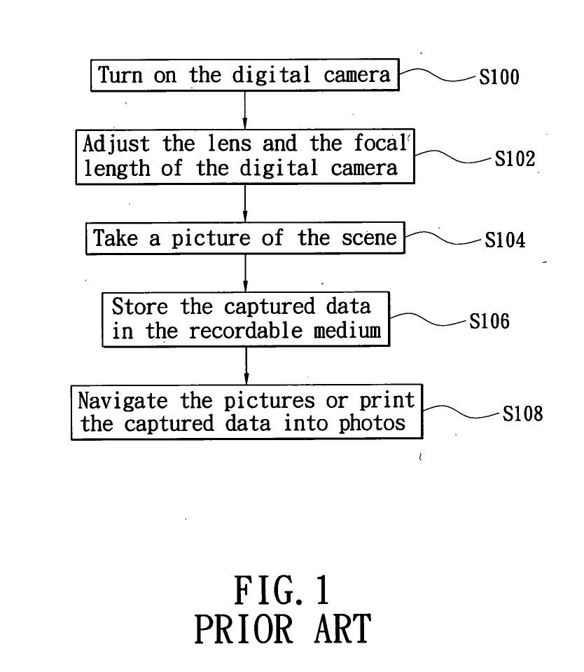

FIG. 2 is the preferred embodiment of the present invention showing the block diagram of a camera device having an odor recording function; and

FIG. 3 is the preferred embodiment of the present invention showing the flow chart about how the proposed photographing method records odor.

### DETAILED DESCRIPTION OF THE PREFERRED EMBODIMENTS

Recently, the hand-held camera devices (such as digital cameras, PDAs, or video cameras) have become popular consuming devices. With the development of technology, these digital hand-held devices not only provide the basic photographing function, but also provide a variety of additional functions such as video recording and voice memo recording. However, although the hand-held camera devices provide many useful functions, they still cannot record odor or smell. Thus, the present invention proposes a device and a method to enable the user to record the environmental odor for enhancing the user experience and the extra value of hand-held camera devices.

An embodiment illustrating how the invention embeds the environmental odor into a digital image file when the user uses the hand-held camera device to take a picture is presented below. In order to clearly illustrate the present invention, a digital camera is borrowed to represent the hand-held camera device in the following description. It should be noted that this embodiment is used as an example merely, and a hand-held camera device is not limited to be a digital camera.

The JPEG file format is the most popular file format used widely in digital cameras when storing the images captured as files. When storing image data in JPEG file format, the JPEG algorithm firstly transforms the image data from spatial domain into frequency domain. Then, based on the concept of human eyes are insensitive to high frequencies, part of the high frequencies of the transformed result are removed. So, the size of the image data can be reduced significantly. Also, the JPEG file format allows extra information to be embedded in the header of the file, which is called EXIF (Exchangeable image file format) information. Most digital cameras embed the settings used for taking the photo, such as focus setting, date and time, into the EXIF section of the JPEG file while storing the photographed image as a file.

In the following description, a digital camera is used as the example to illustrate the preferred embodiment of the camera device having an odor recording function. In order to clearly and simply illustrate the preferred embodiment of the present invention, some essential circuit blocks are disclosed. However, in addition to the following circuit blocks, a digital camera still includes other circuits and the necessary mechanism.

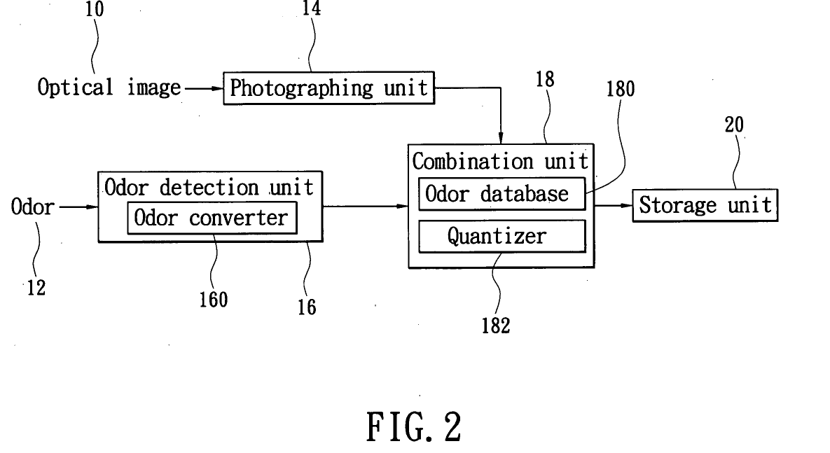

FIG. 2 is the preferred embodiment of the present invention. It shows a block diagram of the camera device having an odor recording function. This camera device comprises a photographing unit 14, an odor detection unit 16, a combination unit 18, and a storage unit 20.

The photographing unit 14 converts at least one optical image 10 into at least one digital image. The odor detection unit 16 contains an odor detector which detects at least one odor 12 of the photographing spot around the photographing unit 14. The odor converter 160 contained in the odor detection unit 16 converts the odor detected into at least one odor in digital form. The combination unit 18 comprises an odor database 180 and a quantizer 182. The odor database 180 is a set of some predefined odors and each odor has a unique code assigned. For example, the code of the apple odor is 1000, the code of the grape odor is 1001, and so on. The quantizer 182 quantizes the detected and sorted odors so that the size of the odor data to be stored can be reduced significantly. The combination unit 18 combines the digital image data with the digital odor data and forms at least one image file, where the odor data are stored in the EXIF section of the generated file. All the generated files are stored in the storage unit 20. The storage unit 20 can be a built-in memory or an external memory card.

The operating process of the camera device having an odor recording function is illustrated as below. When the user operates the camera device having an odor recording function to take a picture, the photographing unit 14 is functioned to take a picture of the scene. The scene captured is converted into at least one digital image. When the picture is taking, the odor detection unit 16 is also operated to detect at least one odor 12 around the photographing spot. The odor converter 160 in the odor detection unit 16 then converts the odor 12 into digital form.

Next, the controller (not shown in the figure) in the digital camera transmits the digital image data and odor data to the combination unit 18. The combination unit 18 first saves the image data as a file, then quantizes the odor data (if needs), and finally embeds the quantized or non-quantized odor data into the specific section of the just generated image file. An image file with the odor data is finally formed and stored in the storage unit 20.

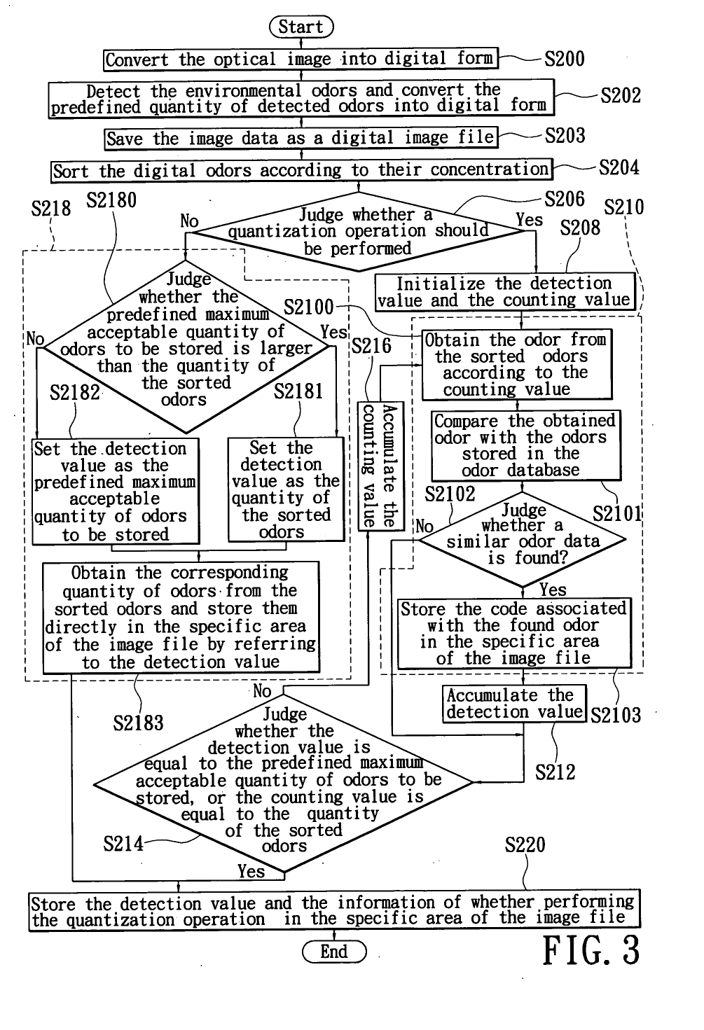

Reference is made to FIGS. 2 and 3, where FIG. 3 is the preferred embodiment of the present invention showing the flow chart of the proposed odor recording method. Firstly, the user operates the photographing unit 14 in the digital camera to take a picture of a scene 10. The scene captured is then converted into digital form (S200). During taking the picture, the odor detection unit 16 detects at least one odor 12 of the photographing spot and converts the considered quantity of detected odors into digital form (S202). Here the considered quantity can be predefined by the manufacturer of the digital camera according to the hardware capability of the digital camera. The digital image data is saved as an image file (S203) before going further. Then, all the digital odors detected are sorted by the controller (not shown in the figure) of the digital camera according to their concentration (S204).

After the odors are sorted, the controller determines whether a quantization operation should be performed or not according to a quantization flag (S206). Here this flag can be a predefined setting or be set by the user. For example, after the sorting operation (S204) is finished, a menu may appear and allow the user to choice whether the quantization operation should be executed. If the user selects the option on the menu to perform the quantization operation, the firmware in the digital camera initializes a detection value and a counting value (S208), and performs the quantization operation (S210). The step S210 includes some sub-steps (step S2100 to step S2103). Firstly, the odor corresponded to the counting value is obtained from the sorted odors (S2100). This obtained odor is compared with the odors stored in the odor database 180 one by one to check whether both the odors are matched (S2101). The step S2101 can be implemented by comparing the waveform of the odor data. Next, whether a similar odor is found can be determined (S2102). In step S2102, when a similar odor is found, the code associated with this found odor is stored in a specific area, such as the EXIF section, of the digital image file (S2103). Afterwards, the detection value is accumulated by one (S212).

In step S2102, if no similar odor is found, it checks whether the detection value is equal to the predefined maximum acceptable quantity of odors to be stored or the counting value is equal to the quantity of the sorted odors (S214). The maximum acceptable quantity of odors to be stored is a predefined value which indicates how many detected odors can be stored in the EXIF section of the generated image file. The same, it can be defined by the manufactures for example. In step S214, if the result is negative, the firmware accumulates the counting value (S216), and keeps finding a similar odor from the odor database 180 for the next detected odor. In step S214, if either condition is matched, the firmware stores the detection value and the quantization flag, which indicates whether the quantization operation is performed or not, in the specific area of the digital image file (S220).

An example is given for illustrating the quantization operation (S210). Let the maximum acceptable quantity of odors to be stored be 10, the quantity of the detected and sorted odors be 15, and the quantity of the odors contained in the odor database 180 is 20. Firstly, the firmware initializes the detection value as 0 and the counting value as 1. Then, the firmware obtains the odor from the sorted odors corresponded by the counting value. That is, the first odor is obtained. The obtained odor is compared with the odors contained in the odor database 180 one by one to check whether both odors are matched or not. If a similar odor is found, the code associated with this found odor is stored in a specific area of the digital image file. Next, the detection value is changed to 1, which indicates one odor has been quantized successfully. If no similar odor is found, the above steps are skipped. At this time, the firmware judges whether the detection value is equal to the maximum acceptable quantity of odors to be stored or the counting value is equal to the quantity of the total sorted odors.

In the above judgment, if the answer is negative, it means there still have odors to be quantized. The counting value is accumulated by one, which is changed to 2 now. Repeatedly, each of the odor corresponded by the counting value can be obtained from the sorted odors and quantized until the detection value is equal to the maximum acceptable quantity of odors to be stored or the counting value is equal to the quantity of total sorted odors. In this example, if each detected and sorted odor can find its similar odor from the odor database 180, then the quantization operation will be terminated when the detection value reaches 10, which is the maximum acceptable quantity of odors to be stored. In other words, 10 quantized results of the 15 odors detected will be stored.

In step S206, when the user selects a non-quantization option from the menu, the firmware in digital camera performs a non-quantization operation (S218). That is, the raw data of part or all the detected and sorted odors will be stored in the specific area of the image file directly. The step S218 includes some sub-steps. The step S2180 judges whether the maximum acceptable quantity of the odors to be stored is larger than the quantity of the detected and sorted odors. If the result is positive, the detection value is set as the quantity of the detected and sorted odors (S2181). Otherwise, the detection value is set as the maximum acceptable quantity of the odors to be stored (S2182). Next, by referring to the detection value, the firmware in digital camera obtains the corresponding quantity of odors from the sorted odors and stores them directly in the specific area of the digital image file (S2183).

Two examples are given below for illustrating the result of step S218. Let the maximum acceptable quantity of the odors to be stored be 10, and the quantity of the detected and sorted odors be 5. Due to the quantity of the maximum acceptable odors is larger than the quantity of the detected and sorted odors, the detection value is set as 5, and the firmware obtains 5 odors from the sorted odors and stores them directly in the specific area of the digital image file. Now, if the maximum acceptable quantity of odors to be stored is 5 and the quantity of the sorted odors is 10, the detection value will be set as 5 and only 5 of the 10 sorted odors will be stored, because the maximum acceptable quantity of odors to be stored is smaller than the quantity of the sorted odors. The firmware in digital camera stores the sorted odor data in the specific area of the digital image file.

Compared with the quantization operation (S210) and the non-quantization operation (S218), the quantization operation (S210) only stores the code associated with the odors in the odor database 180 to represent the detected odors, and the non-quantization operation (S218) stores the raw data of the detected odors directly.

No matter a quantization operation in the step S210 or a non-quantization operation in the step S218 is performed, the digital camera stores the detection value and the information about whether a quantization operation is performed or not in the specific area of the digital image file (S220). For the above example, the value 5 is stored.

The present invention has the following characteristics. The user can record the environmental odor while taking pictures, which enhances the entertainment and memory when viewing the pictures taken. For example, if the computer used for browsing the pictures is connected to an odor dispersing unit, and a photo browser capable of recognizing the odor information is installed in the system, then the user can view the picture and smell the odor together. That is, when the photo browser loads a picture containing the odor information, the browser will detect the odor information stored in the EXIF section of the image file and transmit the corresponding signal to the odor dispersing unit. After the odor dispersing unit receives the signal, it can disperse the corresponding odor. Also, if the user wants to print the digital picture containing the odor information, and the printer used possesses the ability of recognizing the odor information and odor printing, then the user can have a printed version of the digital picture dispersing the designated odor. That is, the printer will recognize the odor information and attach the molecules of the corresponding odor on the paper when printing.

The description above only illustrates the specific embodiments and examples of the invention. The invention therefore should cover various modifications and variations made to the herein-described structure and operations of the invention, provided they fall within the scope of the invention as defined in the following appended claims.

What is claimed is:

1. A camera device having an odor recording function, comprising:
a photographing unit for converting at least one optical image into at least one digital image;
an odor detection unit for detecting at least one odor of the photograph environment and converting the odor into digital form,
a combination unit for quantizing the detected odors if needs and combining the odor data with the digital image data to form at least one image file with the odor data; and
a storage unit for storing the image files containing the odor data.

2. The camera device having an odor recording function as claimed in claim 1,
wherein the odor detection unit further comprises an odor converter for converting the odor into digital form.

3. The camera device having an odor recording function as claimed in claim 1,
wherein the combination unit further comprises:
a quantizer for quantizing the detected and sorted orders; and
an odor database, which contains a set of some predefined odor data, and
each odor has a unique code associated.

4. A photographing method for recording odor, comprising:
using a photographing unit to take a picture on a scene to generate a digital image;
using an odor detection unit to detect at least one odor of the photograph environment, and converting the odor into at least one digital odor;
saving the image data as a file and storing the file in the storage unit;
sorting the odors detected according to the concentration of the odors;
judging whether a quantization operation or a non-quantization should be performed;
quantizing the detected and sorted odors if needs;
storing the quantized or non-quantized odor data within the specific area of the generated image file; and
storing the detection value and the information of whether a quantization operation is performed in a specific area of the digital image file.

5. The photographing method for recording odor as claimed in claim 4, wherein a quantization operation is performed when the result of the step of judging whether to perform a quantization operation is positive and a non-quantization operation is performed when the result of the step of judging whether to perform a quantization operation is negative.

6. The photographing method for recording odor as claimed in claim 4, wherein
the quantization operation further comprises:
initializing the detection value and a counting value;
obtaining the odor data that corresponds to the counting value from the sorted odor data;
comparing the odor data that corresponds to the counting value with a plurality of odor data contained in an odor database to check whether both odor data are matched;
judging whether a similar odor is found in the odor database;
storing the code associated with the found odor in the specific area of the image file; and
judging whether the detection value is equal to the maximum acceptable quantity of odors to be stored or the counting value is equal to the quantity of the sorted odors;

7. The photographing method for recording odor as claimed in claim 6, wherein the step of storing the code associated with the found odor in the specific area of the digital image file is performed when the result of the step of judging whether a similar odor is found is positive, and it further comprises a step of accumulating the detection value.

8. The photographing method for recording odor as claimed in claim 6, wherein the step of determining whether the detection value is equal to the maximum acceptable quantity of odors to be stored or the counting value is equal to the quantity of the sorted odors further comprises the step of accumulating the counting value.

9. The photographing method for recording odor as claimed in claim 4, wherein
the non-quantization operation comprises:
judging whether the maximum acceptable quantity of odors to be stored is larger than the quantity of the sorted odors; and
storing the odor data in the specific area of the digital image file.

10. The photographing method for recording odor as claimed in claim 9, wherein the detection value is set to be the quantity of the sorted odors when the result of the step of judging whether the maximum acceptable quantity of the odors to be stored is larger than a quantity of the sorted odor data is positive, and the detection value is set to be the maximum quantity of the odors to be stored when the result of the step of judging whether the maximum quantity of the odor to be stored is larger than the quantity of sorted odors is negative.
